(19) United States
(12) Patent Application Publication
(10) Pub. No.: US 2023/0262304 A1
(43) Pub. Date: Aug. 17, 2023

(54) WEBCAM MOUNT

(71) Applicant: HUMANCENTRIC VENTURES LLC, Skokie, IL (US)

(72) Inventors: Simcha Kanter, Skokie, IL (US); Bryant Deakins, Des Plaines, IL (US)

(73) Assignee: HUMANCENTRIC VENTURES LLC, Skokie, IL (US)

(21) Appl. No.: 17/671,782

(22) Filed: Feb. 15, 2022

(51) Int. Cl. H04N 5/225; H04N 5/232; G03B 17/56

(52) U.S. Cl. CPC H04N 5/2253; H04N 5/23299; G03B 17/561

(57) ABSTRACT

A webcam support apparatus (10) includes a mount (16) configured to be supported from a computer monitor display screen (14) and a separate camera support that can accommodate a variety of different styles of webcams (12). The camera support may include a base (36) that can be supported directly on the mount or suspended from the mount by suspension cables (58) at a position in front of the display screen. The cables are attached to the camera support at respective spaced apart support locations (60), thereby providing sturdy, balanced support for the webcam. The mount may include a front lip (44) and an optionally removable rearward bracket (28) to provide secure support atop a narrow display screen. A tilt mechanism (42) allows a direction of view (40) of the webcam relative to its support to be adjusted.

### FIELD OF THE INVENTION

This invention relates generally to video equipment, and more particularly to an apparatus for supporting a video camera from a display screen associated with a computing device.

### BACKGROUND OF THE INVENTION

A camera that is connected to a computer system for producing still images and/or video data is commonly referred to as a webcam. While webcams have been used since the 1990's, their use has increased significantly as a result of the popularity of remote conferencing during the recent pandemic.

Webcams are relatively inexpensive due to the low resolution necessary to support video conferencing. Some computer displays, including those used with laptop computers, have a webcam integrated directly into the frame of the display. Free standing webcams are commonly desk mounted or are supported from the frame of a computer monitor in any number of different arrangements, including those briefly described below.

United States patent application publication number US 2021/0006751 A1 discloses a moveable armature attached to a computer monitor for supporting a small camera head at various locations in front of the monitor screen.

United States patent application publication number US 2004/0207718 A1 discloses supporting a camera on a strap wrapped around a computer monitor or on a line supported from the top of the computer monitor.

U.S. Pat. No. 8,817,176 B2 discloses a webcam supported from a belt which is wound around a spring-loaded shaft, in the manner of a window blind.

U.S. Pat. No. 6,943,843 B2 discloses attaching a camera directly to a computer display screen with an attachment mechanism such as a suction cup, double-sided tape, or magnets.

Many existing webcam support arrangements are unique to a particular camera design.

Other existing webcam systems are designed for a fixed placement at the top of the user's display monitor or at the top of a desktop stand. Both of these types of webcam systems fail to provide ease of movement of the camera position or adjustability of the camera's direction of view in a manner that keeps the webcam in a convenient position for the next use.

It would be desirable to have a webcam support arrangement that could be used with a variety of existing webcams and that allows the webcam to be positioned either above or in front of a computer display screen during use that aligns the primary user's normal line of sight with the displayed images of other participants in the videocall so that the primary user appears to be looking directly at the other participants in a more normal, conversational, arrangement.

### SUMMARY OF THE INVENTION

It is an object of the present invention to provide a supporting platform for a webcam that is vertically, continuously, adjustable in position along a vertical axis from the top of a display monitor to a midpoint position of said monitor.

It is further an object of the invention to supply a vertically adjustable webcam support that can be positioned manually or by motorized control.

It is also an object of the invention to describe an adjustable support platform that will work with webcams that are discrete from and not integrated with the support platform so that a primary user could use an existing webcam without having to purchase a new webcam.

In accordance with these and other objects of the invention that will become apparent from the description herein, a webcam support apparatus comprising: (a) a mount configured to be supported by a monitor frame above a display screen; (b) a camera support; and (c) at least one suspension cable for suspending the camera support from the mount to position a webcam in front of the display screen when the webcam is supported the camera support, wherein the at least one suspension cable is attached to the camera support.

The webcam support apparatus of the present invention provides users with new options for better videoconferencing with the webcam they currently own. The support device holds the webcam on top of the display and out of the way when not in use but permits the user to readily deploy the webcam into a convenient eye-to-eye viewing position. While the support can be made with an integrated webcam, it need not be to allow the user the flexibility of using an existing webcam, swapping to a different webcam for a different viewing situation, or upgrading to a new camera without having to buy a new support device.

### BRIEF DESCRIPTION OF THE DRAWINGS

FIG. 1 is a perspective view of a webcam support in accordance with an embodiment of the invention.

FIG. 2 is a side view of the webcam support of FIG. 1 supporting a webcam on top of a computer monitor display screen.

FIG. 3 is a perspective view of the arrangement of FIG. 2.

FIG. 4 is a rear perspective view of the webcam support of FIG. 1 with its bracket removed.

FIG. 5 is a perspective view of the arrangement of FIG. 3 with the webcam suspended in front of the display screen.

FIG. 6 is a perspective view of the webcam support of FIG. 1 with its bracket removed and being supported on a computer monitor shelf.

FIG. 7 is a perspective view of the arrangement of FIG. 6 with the webcam suspended in front of the computer monitor display screen.

FIG. 8 is a front view of a webcam support apparatus incorporating a load splitter.

FIG. 9 is a front view of a webcam support apparatus incorporating a sling.

FIG. 10 is a rear view of an L-shaped support frame.

### DETAILED DESCRIPTION OF THE INVENTION

Embodiments of the present invention include a camera support platform upon which any style of webcam may be placed. This allows the user to use a preexisting webcam or to switch webcams easily without rerouting wires around the monitor.

The camera support platform of the present invention includes a camera support base that is supported from a mount that is, in turn, supported on a monitor frame above a computer display screen. The mount may rest directly on top of the display screen if a sufficiently flat area is available, or it may hook over the top frame of the display screen and include a bracket that extends downwardly to bear against the back of the monitor. Such a bracket may be removable and/or adjustable to accommodate display screens of various designs.

For unobstructed view of the display screen, the camera support base may be placed directly on top of the mount. Because the direction of view of the webcam from this location may be too high, a tilt mechanism may be provided to angle the camera support base (and thus the webcam's direction of view) downward to a desired degree.

Alternatively, the camera support base may be removed from the mount and suspended therefrom in order to position the webcam in front of the display screen. A suspension mechanism including one or more cables extending from the mount to opposite sides of the camera support base provides balanced support on either side of the center of weight of the webcam.

With 2-4 cables, one might envision the present webcam support acting like a painter's scaffold that is suspended from a tall building. The cables could be manually pulled down and into position subject to an appropriate counterbalance weight behind the monitor, friction through one or more cable guides, or a spring-biased flywheel that allows the support platform to remain at a selected position. Moreover, an adjustment lock may be provided to allow the lengths of the suspension cables, i.e. the vertical position of the webcam, to be selected by the user.

Alternatively, the one or more support cables can be associated with a motor-driven storage spool to spool or un-spool cabling and thereby raise or lower the connected platform. Activation of the motor-driven spool or spools is by a remote switch that closes the electrical connection for winding or unwinding the motor or motors.

Exemplary embodiments of the invention are described more fully in the detailed description below and in the accompanying drawings.

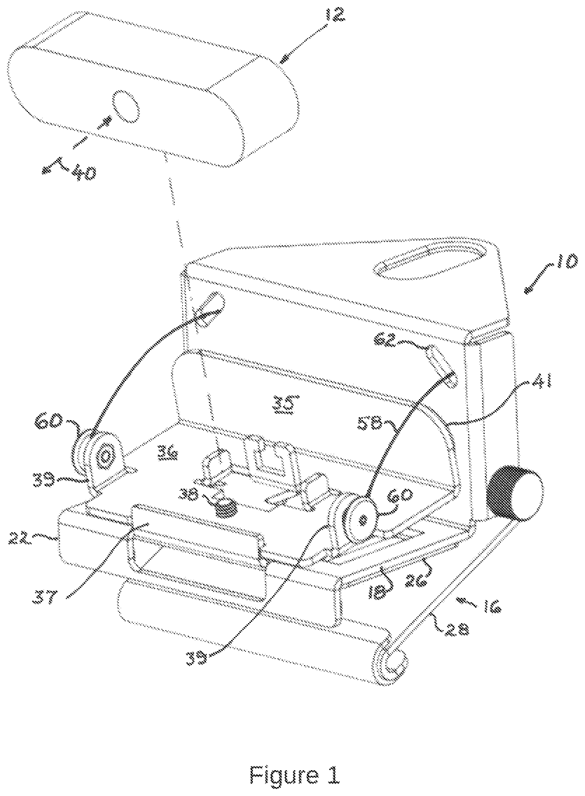

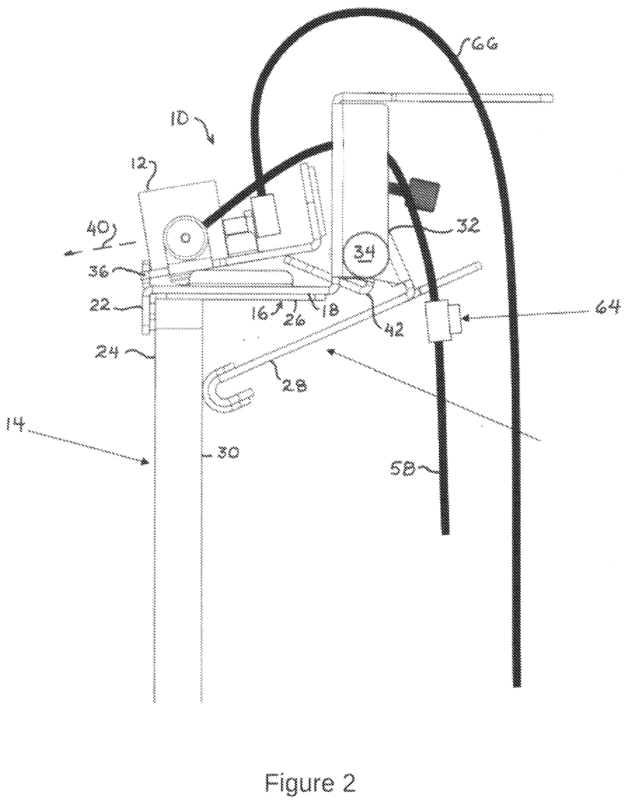

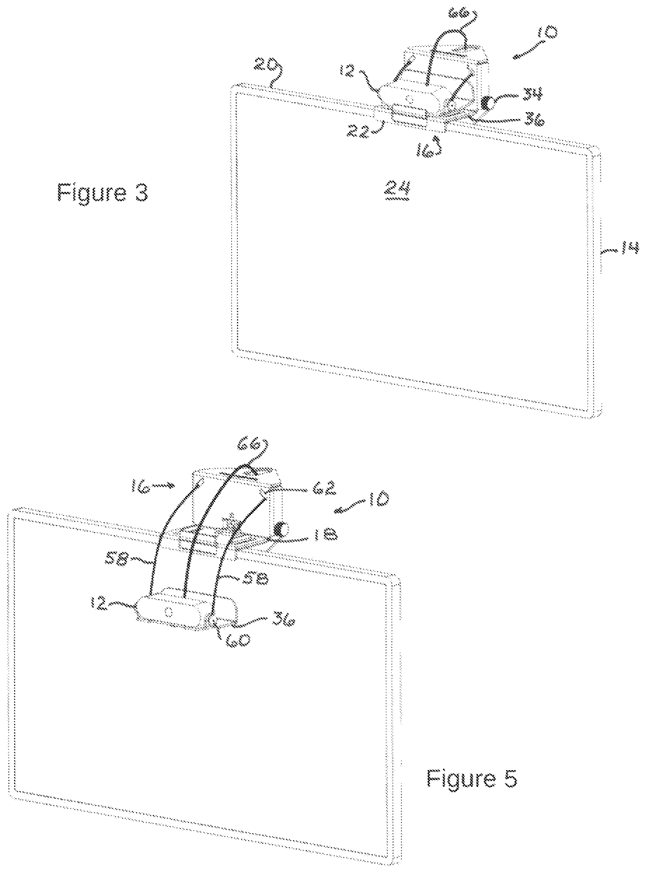

FIG. 1 is a perspective view of a webcam support apparatus 10 which may be used to support a variety of styles of webcams 12 in accordance with an embodiment of the invention. FIG. 2 is a side view of the webcam support apparatus 10 of FIG. 1 with the webcam 12 positioned on top of a computer monitor display screen 14. FIG. 3 is a perspective view of the arrangement of FIG. 2. The following description is best appreciated with reference to all three of these figures since some elements are most clearly illustrated in only some views.

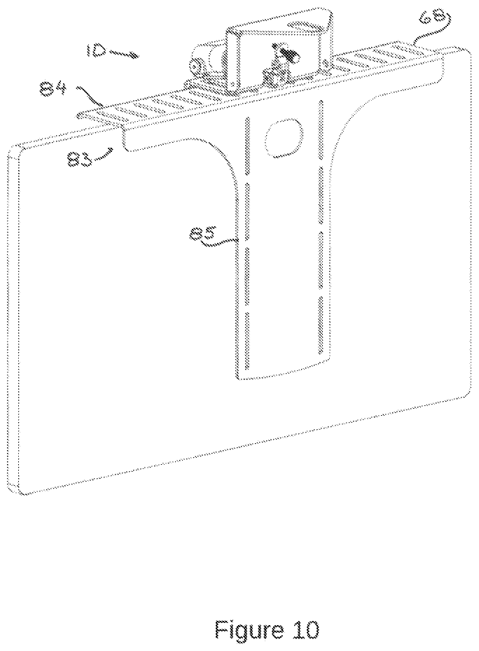

Webcam support apparatus 10 includes a mount 16 configured to be supported by a monitor frame above the display screen 14, such as by simply resting atop the display screen 14 (as illustrated) or by being attached to any portion of the display screen 14 by other means such as a clip, screw, adhesive, hook and loop fastener, etc., or by being supported from a separate structure associated with or located adjacent the display screen 14, such as an L-shaped frame 83 having a top platform 84 rigidly integrated with descending portion 85. (See FIG. 10.)

Monitor mount 16 of the illustrated embodiment includes a monitor mount base 18 for engaging a top surface 20 of the computer display frame that includes display screen 14. The monitor support mount base 18 may be as simple as a flat plate, or it may have openings, appurtenances and/or geometric form as desired for a particular design. For example, the illustrated monitor mount base 18 includes a lip 22 extending downwardly from a front portion of the monitor mount base 18 for engaging a front surface 24 of the frame of display screen 14. Lip 22 facilitates proper positioning of the mount 16 on top of the frame of display screen 14.

Since the mount base 18 may be made from a rigid and potentially abrasive material (e.g. aluminum, steel, plastic, etc.), an optional layer of protective material 26, such as synthetic rubber, cloth, felt, sheet craft foam, etc., may be provided on surfaces of the mount base 18 that will come in contact with the display screen 14. Mount base 18 may also be made from a material that will not scratch or abrade display screen 14.

Most computer monitor display screens 14 and their associated frame structures are relatively thin in their depth dimension and may not present a top surface that is large and flat enough to support and balance the mount 16. For such applications, a supportive bracket, such as bracket lever arm 28, may be provided to extend from a rearward portion of the monitor mount base 18 to engage a rear surface 30 of the display screen 14. Bracket lever arm 28 and lip 22 cooperate to prevent forward movement, rearward movement, and rotation of the mount 16 about an axis substantially parallel to the top of screen 14 when it is positioned atop the display screen 14, while still allowing easy installation onto and removal from the display screen 14.

Since display screens 14 are available in many different designs, some embodiments of the invention may provide ways of adjusting bracket lever arm 28 to accommodate display screens 14 of differing thicknesses. One such way includes a rotatable connection 32 between the bracket lever arm 28 and the mount base 18 about a substantially horizontal axis when positioned atop screen 14. The illustrated bracket lever arm 28 allows a user to rotate the bracket lever arm 28 relative to the mount base 18 about connection 32 to extend or retract bracket lever arm 28 so as to make stable contact with the rear surface 30 of the display screen 14, and then lock the bracket lever arm 28 into the selected position by tightening a frictional engagement via knob 34.

In another embodiment (not illustrated), a length of a portion of the bracket lever arm 28 may be varied by the user, such as with an adjustable/lockable telescoping or sliding member, to make stable contact with rear surface 30.

The preferred embodiment of the present invention has camera support platform 36 resting on mount 16 when eye-to-eye contact is not needed or the webcam is not in use but suspended from mount 16 with one or more suspension cables 58 that allow support platform 36 to be lowered over front surface 24 into the desired position for eye-to-eye viewing. The illustrated embodiment utilizes a camera support in the form of a camera support platform 36, with the webcam 12 simply being laid on top of the camera support platform 36. Alternatively, webcam 12 may be more firmly affixed to support platform 36, such as with a threaded fastener 38 or other type of permanent or releasable connection, e.g., a clip, snap, contact cement, hook-and-loop fastener, etc. The camera support platform 36 provides a platform for a variety of styles, sizes, and shapes of cameras, thereby enabling support for a plurality of known and future webcam designs.

As shown, camera support platform 36 is generally planar and rectangular in shape with a raised rear plate portion 35, a raised front plate portion 37, and at least one, preferably two, raised flanges 39 that can be used to secure suspension cables 58. Rear face 41 of raised portion 35 is intended for contact display screen 14 when support platform 36 is in a deployed, suspended position. Accordingly, rear face 41 is preferably ma de from or covered with a material that will not scratch or abrade the contacted material of display screen 14. Suitable covering materials include felt, cushioning fabrics, plastic coatings, and the like.

FIGS. 1-3 illustrate the camera support base 36 resting directly on top of the mount 16, which in turn positions the webcam 12 at the top of the display screen 14. This position may provide a direction of view 40 of webcam 12 that is higher than desired. Accordingly, webcam support apparatus 10 is provided with a tilt mechanism 42 extending upwardly from a rearward portion of the mount base 18 for engaging an underside of the camera support base 36, thereby tilting the camera support base 36 forward and tilting the direction of view 40 downward from horizontal. To prevent the webcam 12 from sliding forward on the mount 16 as a result of this tilt, a lip 44 may be formed to extend upwardly from the front portion of the mount base 18 for engaging a front portion of the camera support base 36.

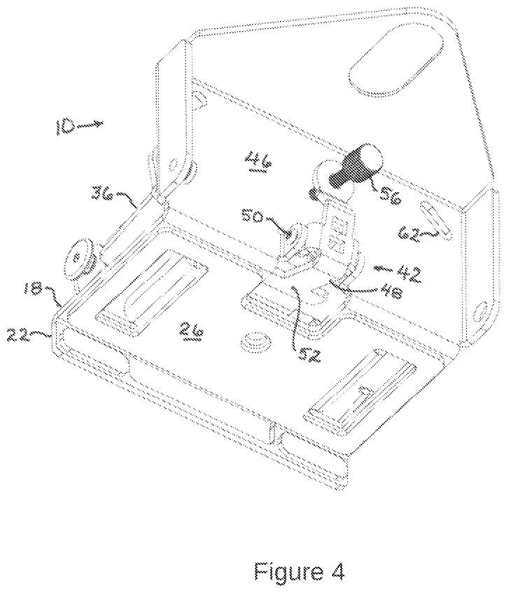

FIG. 4 provides a rear perspective view of the webcam support apparatus 10 with the bracket lever arm 28 removed in order to more clearly illustrate the depicted embodiment tilt mechanism 42. Support mount base 18 includes an upwardly extending wall 46. Tilt mechanism includes a lever 48 rotatably attached about axis of rotation 50 relative to the mount base 18. A first end 52 of the lever 48 extends to engage and lift the rear portion of the underside of the camera support base 36. A second end 54 of lever 48 extends to engage the upwardly extending wall 46 by means of a positioner 56 which acts as a stop to the rotation of the lever 48 caused by the weight of the camera support base 36 being exerted through the first end 52 of the lever 48. In the illustrated embodiment, positioner 56 is a threaded set screw, although other types of adjustment mechanisms could be used. A user is thus able to adjust an angle of the lever 48 relative to the mount base 18, and thereby adjust the direction of view 40 of a webcam 12 that is positioned on the camera support base 36, by simply rotating the set screw positioner 56.

While FIG. 3 illustrates the webcam support apparatus 10 with the webcam 12 positioned at the top of the display screen 14, it is often desired to position a webcam 12 at a lower height, such as to achieve a desired alignment of the webcam 12 with a user's face during teleconferencing. FIG. 5 illustrates the webcam support apparatus 10 of FIG. 3 with the camera support base 36 and webcam 12 suspended from the mount 16 in front of the display screen 14 by a pair of suspension cables 58. The suspension cables 58 are attached to the camera support base 36 at respective spaced apart support locations 60 on the camera support base 36, then extend to pass through cable openings 62 in the upwardly extending wall 46 of mount base 18. The cables 58 may be wire, plastic, rubber or any other material having sufficient strength and flexibility for a particular application. An adjustment lock 64 (see FIG. 2) may be associated with each suspension cable 58 to selectively limit a length of each cable 58 extending between the mount 16 and the camera support base 36, such as by creating a mechanical interference between the adjustment lock 64 and the size of the opening 62. The position of the adjustment lock 64 on the cables 58 may be adjusted to allow the camera support base 36 to hang at a desired height below the mount 16, such as by loosening a setscrew to allow the lock 64 to slide along the cable 58. Electrical connection(s) for the webcam 12, such as a USB cable 66, may be routed independently from the apparatus 10 or routed through an opening or other support/guide structure in the mount 16. In some embodiments, an electrical connection for the webcam may also function as part of the suspension mechanism for the camera support, such as by using a USB cable as a suspension cable. By supporting the camera support platform 36 from one or more locations, such as by at least two spaced apart support locations 60, the present invention provides sturdy, balanced support for the webcam 12 in its suspended configuration. The use of a single support location 60 can be achieved with positioning location 60 at atypical balance point for an expected center of gravity, with a wide connector, a wide cable, or by threading a standard USB cable through a frictionally-engageable opening in a lateral arm (not shown) that would provide a measure of lateral balancing force to level the supported webcam.

The illustrated embodiment includes two completely separate suspension cables 58, and they may be associated with two separate adjustment locks 64. Alternatively, a single lock 64 may be designed to engage both cables 58.

Embodiments which enable the length of each cable or cable end to be independently adjustable allow the camera support base 36 to be maintained level or purposely not level. A further embodiment may have the adjustment lock 64 attached to the mount 16 with the cable 58 selectively held by the lock 64 once the camera support base 36 is in a desired suspended position.

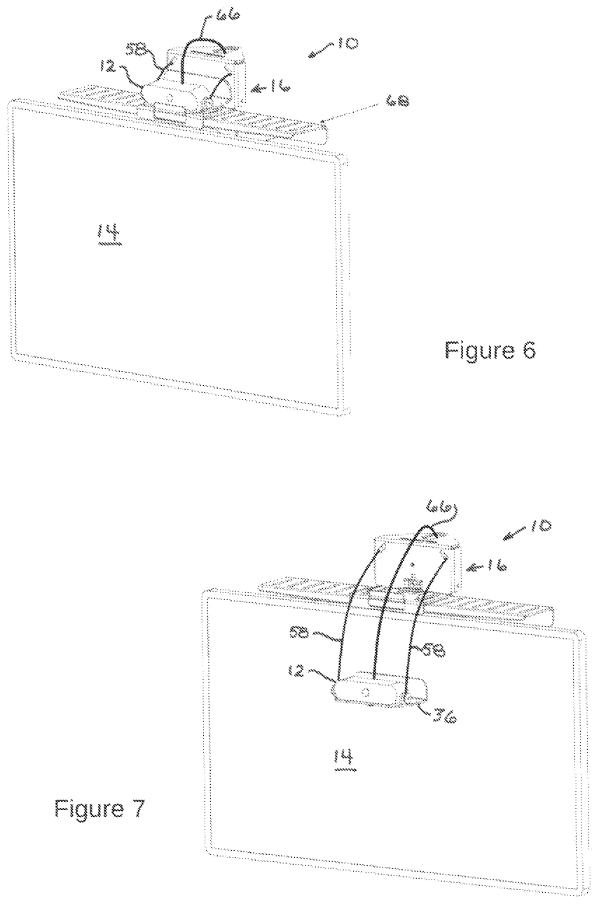

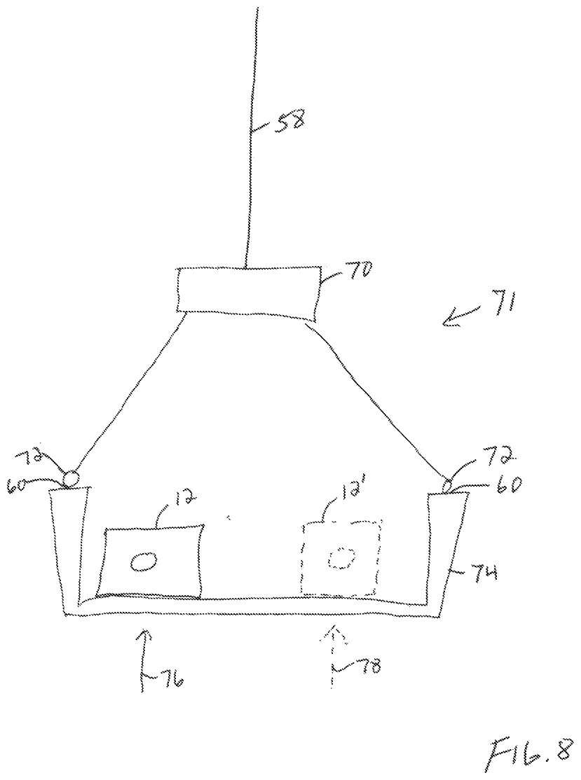

FIG. 6 is a front perspective view of the webcam support apparatus 10 of FIG. 1 installed on a computer monitor display screen 14 that has been equipped with a commercially available computer monitor shelf bracket 68. The shelf bracket 68 provides a flat upper surface that is adequate to support the webcam support apparatus 10 without need for the bracket lever arm 28 described above (see FIGS. 1-3). Accordingly, another way of configuring the bracket lever arm 28 may enable the removal of the bracket lever arm 28 from the mount base 18, such as by complete removal of the frictional engagement knob 34, thereby allowing the bracket lever arm 28 to be separated from the mount 16. FIG. 6 illustrates the webcam 12 positioned directly on the mount 16, and FIG. 7 illustrates the same arrangement but with the camera support platform 36 and webcam 12 positioned vertically downwardly and suspended at a position in front of the display screen 14 by a pair of cables 58. Pressure against screen 14 forms a stable plane of support for support platform 36.

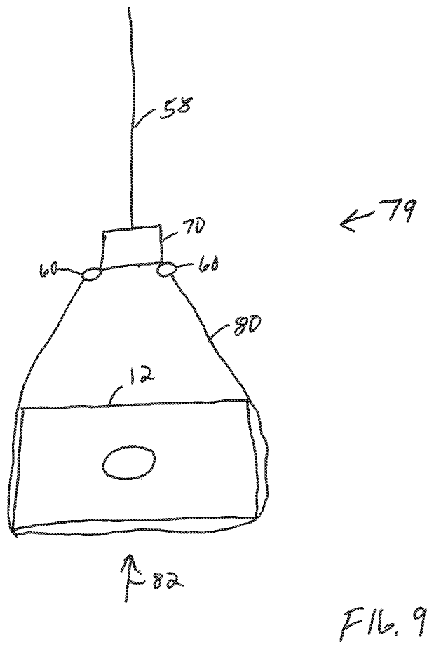

FIG. 8 illustrates another embodiment of a webcam support apparatus 71 where a single suspension cable 58 extends from a mount (not shown) to/through a load splitter 70, such as a cabled yoke, to a plurality of ends 72 terminated at spaced apart support locations 60 on a camera support platform 74. FIG. 8 illustrates one way to form support locations 60 with a single support cable 58.

Since the webcam support platform 74 is sufficiently large to accommodate various sizes/designs of webcams, the position of any given webcam 12 on the camera support platform 74 may vary somewhat (from left to right in the figure). With the webcam 12 in a leftmost position on the camera support 74 (illustrated with solid lines), a center of weight of the webcam 12 is indicated by first arrow 76. Alternatively, a webcam 12′ (indicated in phantom) may be located at a rightmost position on the camera support platform 74 where its center of weight is indicated by second arrow 78. By splitting the support forces with load splitter 70 to ends 72, support locations 60 are sufficiently far apart to maintain stability when the webcam 12 is moved anywhere within the range of available left-to-right positions on the support platform 74. This is accomplished in the embodiment of FIG. 8 by keeping the center of weight 76/78 between the two support positions 60.

In lieu of a load splitter 70, other embodiments may utilize a single suspension cable having a left/right width sufficiently large such that the edges of the cable function as spaced apart support locations providing stability to accommodate left/right movement of the webcam on the camera support.

FIG. 9 illustrates another embodiment of a webcam support apparatus 79 where the camera support is formed as a sling 80. The sling 80 may be any sufficiently strong and flexible material for receiving and supporting a variety of webcams 12 of different designs. Sling 80 has opposed ends which are connected to one or more suspension cables 58 and which function as spaced apart support locations 60 which stably support the webcam's center of weight 82.

While various embodiments of the present invention have been shown and described herein, it will be obvious that such embodiments are provided by way of example only. Numerous variations, changes in the order of steps, and substitutions may be made without departing from the invention herein.

What is claimed is:

1. A webcam support apparatus comprising:
a camera support platform, and
at least one suspension cable supportingly associated with said support platform and configured to allow said support platform to become positioned into a first position in front of a display screen of said monitor case and to retract said support platform to a second position above said display screen, said support platform configured to support a webcam placed thereon, the at least one suspension cable attached to the camera support at spaced apart support locations on the camera support.

2. The apparatus of claim 1, further comprising an adjustment lock associated with the at least one suspension cable and configured to selectively limit a length of the at least one suspension cable extending between the mount and the camera support.

3. The apparatus of claim 1, further comprising a support mount base that engages a top surface of the display screen and is dimensioned to support said camera support platform when in said second position.

4. The apparatus of claim 3, wherein the support mount further comprises a bracket extending from a rearward portion of said support mount base that engages a rear surface of the display screen.

5. The apparatus of claim 4, wherein said bracket is removably attached to said support mount base.

6. The apparatus of claim 4, wherein said bracket rotates about a horizontal axis and adjust its position to support the mount on display screens of differing thicknesses.

7. The apparatus of claim 6, wherein the bracket is secured in a position relative to the mount base with a frictional engagement knob.

8. The apparatus of claim 3, further comprising a tilt mechanism extending upwardly from a rearward portion of the mount base for engaging an underside of the camera support platform when the camera support platform is disposed on the mount base, the tilt mechanism effective to angle a direction of view of the webcam downwardly from horizontal.

9. The apparatus of claim 8, further comprising a lip extending upwardly from the front portion of the mount base for engaging a front portion of the camera support platform when the camera support is disposed on the mount base.

10. The apparatus of claim 8, wherein the tilt mechanism further comprises;
a lever arm rotatably attached relative to the mount base;
a first end of the lever arm extending down to engage the underside of the camera support platform; and
a positioner engaged into a second end of the lever that adjustably positions and secures said lever arm at an angle relative to the mount base.

11. The apparatus of claim 1, wherein the at least one suspension cable is attached to the camera support via a load splitter.

12. The apparatus of claim 1, wherein the camera support comprises a sling.

13. A webcam support apparatus comprising:
a monitor mount configured to rest on a frame of a computer display frame;
a camera support platform dimensioned to fit on said monitor mount in a first position; and
a pair of suspension cables attached to opposite sides of said support platform and operably configured to allow said support platform to extend downwardly over a front of the computer display and become positioned into a second position in front of the display screen and to be moved back to said support platform to said first position.

14. A webcam support according to claim 13 further comprising an adjustment lock associated with the at least one of the suspension cables and configured to selectively limit a length of the at least one suspension cable that can be extended as said camera support platform is extended from said first position to said second position.

15. The apparatus of claim 13, wherein the monitor mount further comprises a bracket extending from a rearward portion of the monitor mount that engages a rear surface of the computer display frame.

16. The apparatus of claim 15, wherein said bracket rotates and adjust its position to support the mount on display screens of differing thicknesses.

17. A webcam support apparatus comprising:
a camera support platform; and
at least one suspension cable supportingly associated with said support platform and configured to allow said support platform to become positioned into a first position in front of a display screen of said monitor case and to retract said support platform to a second position above said display screen, said support platform configured to support a webcam placed thereon.
